(19) United States
(12) Patent Application Publication
(10) Pub. No.: US 2008/0212345 A1
(43) Pub. Date: Sep. 4, 2008

(54) DC-DC CONVERTER SYSTEM

(75) Inventors: Tsuyoshi Yamashita, Anjo-city (JP); Mamoru Toda, Chita-gun (JP); Kenji Otsuka, Nagoya-city (JP)

Correspondence Address: OLIFF & BERRIDGE, PLC, P.O. BOX 320850, ALEXANDRIA, VA, 22320-4850, US

(73) Assignees: DENSO CORPORATION, Kariya-City (JP); TOYOTA JIDOSHA KABUSHIKI KAISHA, Toyota-City (JP)

(21) Appl. No.: 11/886,062

(22) PCT Filed: Mar. 17, 2006
(86) PCT No.: PCT/JP2006/305908

§ 371 Date: Sep. 11, 2007

(30) Foreign Application Priority Data
Mar. 24, 2005 (JP) 2005-087004

(51) Int. Cl. H02H 7/10

(52) U.S. Cl. 363/50

(57) ABSTRACT

A DC-DC converter system is provided to improve switching control operation of a battery charging DC-DC converter (3) in an overheat temperature state without necessitating complication of a control unit (4). The control unit (4) performs output voltage limitation as well as output current limitation when the temperature of the DC-DC converter (3) is in an overheat temperature state in the vicinity of its operation stop temperature. With this capability, the output current and the output voltage can be limited, and therefore overheating of a power switching device (32) of the DC-DC converter (3) can be inhibited. In an alternative embodiment the switching frequency of the power switching device (32) is limited.

### TECHNICAL FIELD

This invention relates to a DC-DC converter system that supplies an output from a direct current power supply source by converting by means of switching of a built-in power switching device to an electric load system.

This application is based on and incorporates herein by reference Japanese Patent Application No. 2005-87004 filed on Mar. 24, 2005.

### BACKGROUND ART

For vehicular power supply systems of hybrid vehicles and idle-stop vehicles, dual-battery type vehicular power supply systems are proposed. In this unit, two batteries having different supply voltages are used for a vehicular power supply system. Further, a high voltage battery of a few tens or hundreds volts supplies power to large electric power loads, while a low voltage battery of over ten volts, such as a lead battery, supplies power to low power electric loads. The high voltage battery is charged by a power generating set of a high voltage. The low voltage battery or a low voltage load connected to it is supplied with power from the high voltage battery or the power generating set through a DC-DC converter.

This DC-DC converter performs feedback control of a built-in power switching device so that its output voltage converges to a predetermined target value in order to supply power to this load system with a power supply voltage of the load system that is suited to charge the low voltage battery.

In DC-DC converters of this kind, temperature management of a built-in power switching device is especially important. When the temperature of the power switching device reaches a predetermined operation stop temperature, the operation of the power switching device is stopped.

However, abrupt stop of the power switching device may cause a detrimental effect on a power supply system. For this reason, JP-8-84438A proposes that, when the temperature of the power switching device enters an overheat temperature state in the vicinity of this operation stop temperature, an output current of the DC-DC converter is limited so that overheat of the power switching device is inhibited, and temperature rise of the power switching device is restricted not to rise up to the operation stop temperature. This overheating inhibition type DC-DC converter is a current-limiting type DC-DC converter.

An output current limiting system of the conventional current-limiting type DC-DC converter system is shown in FIG. 4. In this figure, numeral 100 denotes a normal (non-overheat-time) limiting current value, lines 101-103 denote overheat-time limiting current values, respectively, with three states: a normal (non-overheat) temperature state less than temperature T1, the overheat temperature state from T1 to T2, and a stop temperature state more than T2. The line 101 shows a case where the output current is reduced linearly in accordance with temperature rise, the line 102 shows a case where the output current is reduced in steps in accordance with temperature rise, and the line 103 shows a case where the output current is reduced curvilinearly in accordance with temperature rise.

With the above current-limiting type DC-DC converter system, the output current is limited in the overheat temperature state so that the power switching device can be restricted from reaching the stop temperature. Consequently stable feeding with power from a power supply source to a battery of a relatively low voltage can be realized.

However, even in this current-limiting type DC-DC converter system, when a demand of electric supply from a load system is large, the output current of the DC-DC converter is necessarily held at the limiting value (lines 101, 102, 103) in the overheat temperature state. As a result, the overheating inhibition cannot be attained to a satisfactory level.

Moreover, in case where the above control system for limiting the output current depending on a temperature operates erroneously, the temperature of the power switching device tends to exceed the operation stop temperature.

### DISCLOSURE OF INVENTION

This invention therefore has its object to provide a DC-DC converter system that has improved overheat inhibition function of its power switching device without complicating circuit configuration.

According to a first aspect of the present invention, in a DC-DC converter system, at the time of an overheat temperature state, a control unit limits a power switching device so that an output current of the DC-DC converter does not exceed a predetermined overheat-time limiting current value that is smaller than a normal limiting current value equal to a maximum allowable current value at the time of a normal temperature state and so that the output current of the DC-DC converter does not exceed a predetermined overheat-time limiting voltage value that is smaller than the normal limiting voltage value equal to a maximum allowable voltage value at the time of the normal temperature state and that is set in a range equal to or more than the minimum required voltage value required by an electric load system.

That is, the DC-DC converter system limits the output voltage in addition to conventional limitation of the output current in the overheat temperature state in the vicinity of the operation stop temperature. As a result, as compared with a case where only the output current is simply limited, the DC-DC converter system can reduce iron losses of a transformer and a choke coil that do not depend on the current as well as a loss of the power switching device in the overheat temperature state.

In any DC-DC converter system, the output voltage is definitely designed to be set to a voltage higher than a minimum required voltage with some margin in order to charge a low voltage battery sufficiently. Therefore, even when the output voltage value of the DC-DC converter is reduced just above a voltage value where a necessary operation of the load system becomes impossible, the operation of the load system can be secured.

Therefore, the DC-DC converter system performs control of lowering the output voltage of the DC-DC converter with rise of the temperature of the DC-DC converter near the stop temperature in a range of voltage higher than a minimum voltage value required for the operation of the load system, in addition to the control of lowering the output current. By this control, the power loss of the power switching device of the DC-DC converter and the iron losses of the transformer and the choke coil can be reduced more significantly than the conventional current-limiting type DC-DC converter system, as a synergistic effect of lowering the output voltage and lowering the output current. Consequently, the operation stop of the DC-DC converter can be prevented by inhibiting overheat of the power switching device.

Moreover, since the DC-DC converter has an output voltage limiting system operable in the overheat temperature state in addition to the conventional output current limiting system, even when one of the two limiting systems fails, the other limiting system still exists. Therefore, the DC-DC converter can positively inhibit a progress of overheat of the power switching device caused by a failure of output limitation due to an erroneous operation in the overheat temperature state.

In addition, the DC-DC converter system has an advantage that the output voltage limiting system requires almost no additional part in the circuit configuration because of appropriation of the output voltage constant controlling system at the time of the normal temperature state, and therefore does not cause complication of the circuit configuration and resulting increase in cost.

In a preferred embodiment, the control unit reduces both the overheat-time limiting current value and the overheat-time limiting voltage value stepwise or continuously as the temperature rises at the time of the overheat temperature state. By this operation, heat generation of the power switching device can be smoothly controlled at the time of the overheat temperature state.

In a preferred embodiment, the control unit sets the overheat-time limiting voltage value to a value equal to or more than an open-circuit voltage value of the battery as the load system at the time of the overheat temperature state. By this setting, even at the time of the overheat temperature state, the battery of the load system is not allowed to be discharged in the DC-DC converter system. Accordingly it becomes possible to operate the load system smoothly at the time of the overheat temperature state. In addition, in this case, when the temperature of the DC-DC converter exceeds the stop temperature, the DC-DC converter system will stop, and the load system will be able to be operated temporarily only by electric discharge of that battery during when the DC-DC converter system is being cooled.

According to a second aspect of this invention, in a DC-DC converter system, at the time of an overheat temperature state, a control unit decreases a switching frequency of a power switching device to a value lower than that of a normal temperature state.

That is, the switching frequency of the power switching device at the time of the overheat temperature state is reduced from that at the time of the normal temperature state, for example, by a few tenths. The power switching device of the DC-DC converter system is controlled, for example, by PWM feedback control. Normally, in order to reduce noises, switching noise voltage, an output current ripple, etc., the power switching device is operated at a frequency of a few hundreds kHz to a few MHz. However, when the switching frequency is high, a transient loss, namely an on-off loss of the power switching device of the DC-DC converter increases and heating of the power switching device increases. Therefore, considering that it is more important to secure power supply from the DC-DC converter to the load system than solving problems of the noises, switching noise voltage, etc. in the overheat temperature state, electric power is supplied while reducing the switching frequency of the power switching device. This arrangement makes it possible to maintain stable power supply to the load system while heating is inhibited in the overheat temperature state in the vicinity of the stop temperature.

### BRIEF DESCRIPTION OF DRAWINGS

FIG. 1 is a circuit diagram showing a dual-battery type vehicular power supply system according to a preferred embodiment of the present invention.

FIG. 2 is a flowchart showing an output control operation of a controller in the preferred embodiment.

FIG. 3 is a characteristic diagram showing an overheat-time limiting voltage value and an overheat-time limiting voltage value as functions of temperatures in the preferred embodiment.

FIG. 4 is a characteristic diagram showing an output current limiting system of a conventional current-limiting type DC-DC converter system.

### BEST MODE FOR CARRYING OUT THE INVENTION

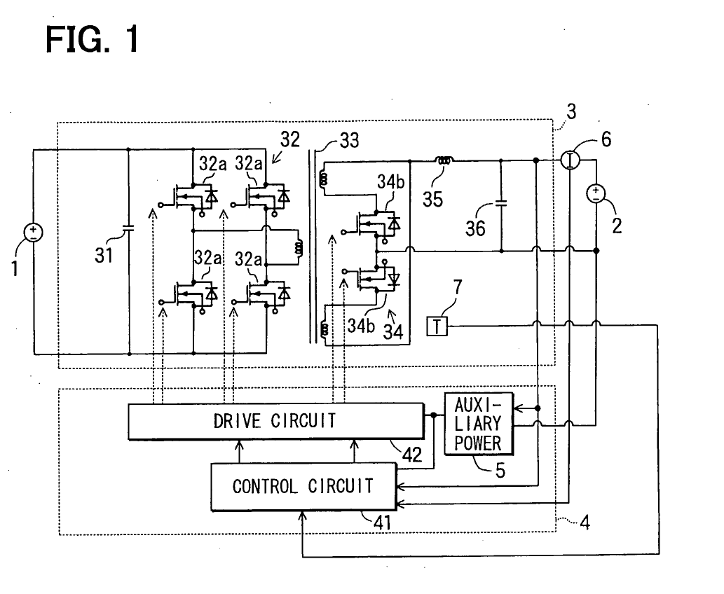

A DC-DC converter system is applied to a dual-battery type vehicular power supply system in a preferred embodiment as shown in FIG. 1.

This dual-battery type vehicular power supply system is connected to a main battery 1 and an auxiliary battery 2, and has a battery charging DC-DC converter 3, a DC-DC converter control circuit unit 4 for controlling a switching operation of this battery charging DC-DC converter 3. This power supply system is constructed to supply electric power to an electronic controller (not shown) from the main battery 1 for charging traction energy of a hybrid vehicle after transforming its voltage and to supply electric power to auxiliary or accessory devices and the auxiliary battery 2 for an auxiliary purpose. The power supply system is also connected to a current sensor 6 and a temperature sensor 7.

The DC-DC converter 3 for battery charging adopts a well-known circuit configuration comprised of an input smoothing capacitor 31, an inverter circuit 32 of a full bridge type, a step-down transformer 33, a synchronous rectifying circuit 34, a choke coil 35 and an output smoothing capacitor 36. This DC-DC converter circuit 3 may be configured in various ways. The choke coil 35 and the output smoothing capacitor 36 form an output smoothing circuit.

The control unit 4 for the DC-DC converter 3 has an electronic control circuit 41 and a drive circuit 42 that forms gate voltages for pulse-width modulation (PWM) control with a control signal inputted from this control circuit 41 and outputs these gate voltages to both MOS transistors 32a of an inverter circuit (switching device) 32 and MOS transistors 34b of a synchronous rectifying circuit 34. The control unit 4 also has an auxiliary power supply 5 for applying a power supply voltage to the control circuit 41 and the drive circuit 42.

The control circuit 41 has a circuit function of reading a current detection value detected by the current sensor 6 for detecting an output current of the battery charging DC-DC converter 3 and an output voltage of the battery charging DC-DC converter 3, and outputting a control signal that reduces a deviation between this output voltage and a predetermined target voltage value to zero. The control circuit 41 has an output control and limit function of controlling or stopping a switching operation of the battery charging DC-DC converter 3 based on an output current of the battery charging DC-DC converter 3 sensed by the current sensor 6, the temperature of the battery charging DC-DC converter 3 sensed by the temperature sensor 7, and an output voltage of the battery charging DC-DC converter 3.

By driving MOS transistors 32a of the inverter circuit 32 with the gate voltages inputted from the drive circuit 42 in the switching manner, an average output voltage of the inverter circuit 32 is PWM-controlled so that the deviation between the output voltage of the battery charging DC-DC converter 3 and the predetermined target voltage value is reduced to zero. Furthermore, a pair of transistors 34b constituting the synchronous rectifying circuit 34 are also switching-controlled in synchronization with respective MOS transistors 32a of the inverter circuit 32 to rectify secondary voltage of the step-down transformer 33 synchronously. The output of the synchronous rectifying circuit 34 charges the auxiliary battery 2 after its voltage is smoothed by the output smoothing circuit.

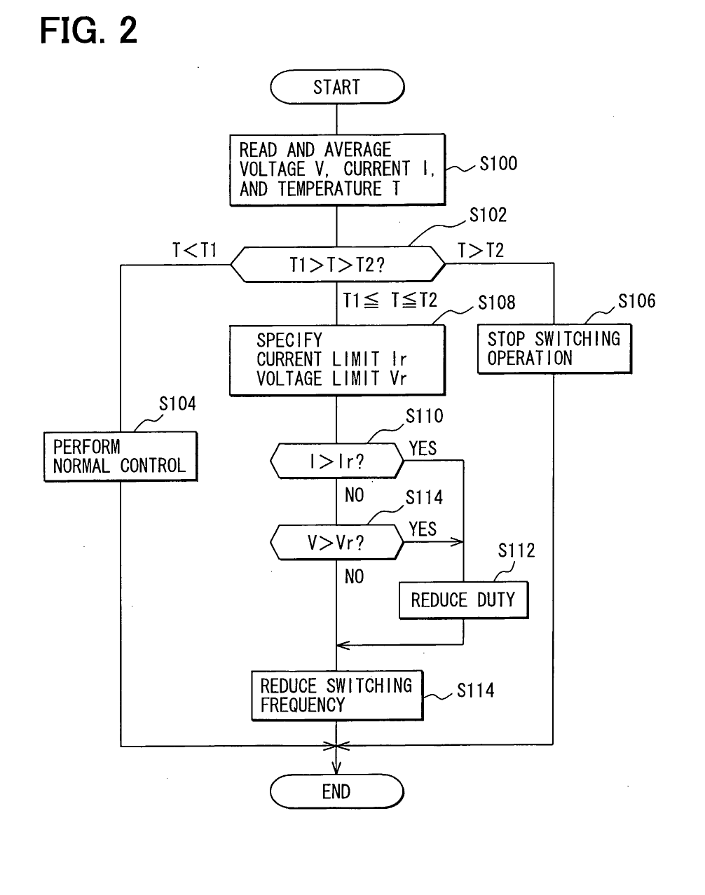

The control circuit 41 may be a microcomputer programmed to perform an output control operation of the battery charging DC-DC converter 3 as shown in FIG. 2. This programmed function may be realized with hardware circuitry.

First, the output voltage V, the output current 1, and the temperature T of the battery charging DC-DC converter 3 are read, and the output voltage V and the output current I are put into averaging processing (step S100). Next, the temperature T is compared with a limiting start temperature T1 used to separate an overheat temperature state (region) and a normal temperature state. It is also compared with an operation stop temperature T2 used to separate the normal temperature state and the stop temperature state. Thus, the state of the battery charging DC-DC converter 3 is determined to one of the normal temperature state, the overheat temperature state and the stop temperature state (step S102).

When the temperature is equal to or less than the limiting start temperature T1, that is, when the battery charging DC-DC converter 3 is in the normal temperature state (T<T1), a normal control is performed (step S104) because it is not necessary to limit the output of the battery charging DC-DC converter 3. This normal control is an operation where the PWM feedback is performed so that the output voltage V may become equal to the predetermined target value VP, the output current I and a predetermined non-overheat-time limiting current value Irm are compared. When the output current I exceeds this non-overheat-time limiting current value Irm, the duty ratio in the PWM feedback control is lowered to limit the output. Since this normal control is well known, further explanation will be omitted.

When the temperature T is more than the stop temperature T2 (T>T2), the switching operation of the battery charging DC-DC converter 3 is stopped so that the power switching device is protected from breakage (step S106). That is, the duty ratio in the PWM feedback control is set to zero.

When the temperature T is in the overheat range between the limiting start temperature T1 and the stop temperature T2, a power saving operation to limit heating of the power switching device of the battery charging DC-DC converter 3 will be performed as follows.

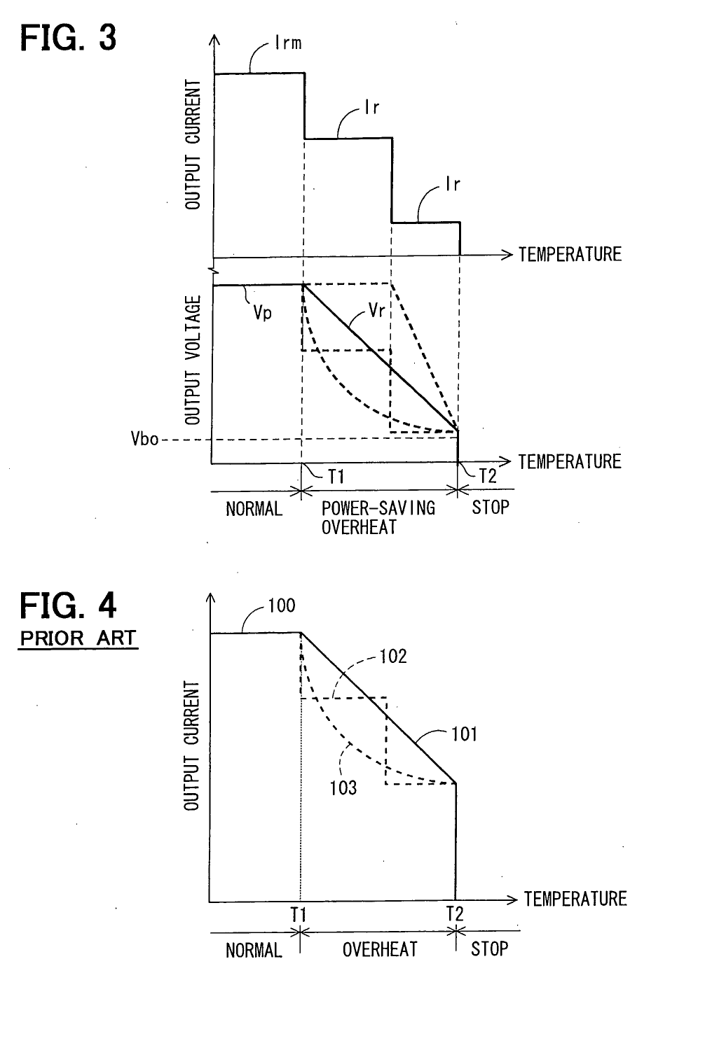

First, the temperature T is specified in a data storing map provided in advance to find an overheat-time limiting current value Ir and an overheat-time limiting voltage value Vr (step S108). FIG. 3 shows one example of this map data. For example, the overheat-time limiting current value Ir is set in steps, while the overheat-time limiting voltage value Vr is set llinearly (a solid line). The overheat-time limiting voltage value Vr may be one of various variants, which are shown by dotted lines in FIG. 3.

Next, the output current I and the overheat-time limiting current value Ir are compared (step S110). When the output current I is larger than Ir, a duty ratio of the power switching device of the battery charging DC-DC converter 3 that is PWM-controlled is reduced by a predetermined value (step S112). When the output current I is not larger than Ir, the output voltage V and the overheat-time limiting voltage value Vr are compared (S114). When the output voltage V is larger than Vr, the duty ratio of the power switching device of the battery charging DC-DC converter 3 that is PWM-controlled is reduced by the predetermined value (step S112).

After steps S112 and S114, a switching frequency in the PWM feedback control is reduced to half, thus ending this routine and returning to a main routine (not shown). The above routine is periodically executed.

As shown in FIG. 3, the minimum value of the overheat-time limiting voltage value Vr is set higher than an open circuit voltage Vbo of the auxiliary battery 2. By this setting, although the output voltage of the battery charging DC-DC converter 3 is limited in this overheat temperature state, the battery charging DC-DC converter 3 can charge the auxiliary battery 2. Consequently there arises no risk of overcharging the auxiliary battery 2 even when the battery charging DC-DC converter 3 is in the overheat temperature state for a long period.

In this embodiment, the temperature sensor 7 is provided in the proximity of the synchronous rectifying circuit 34. The temperature sensor 7 may be disposed in any areas where the internal temperature of the battery charging DC-DC converter 3 is detectable. For instance, the temperature may be detected based on the temperature of a cooling system for cooling the DC-DC converter 3. Alternatively, the temperature of the battery charging DC-DC converter 3 may be estimated by other detection parameters, such as a history of the current sensor 6 and the outside temperature.

Many other modifications are possible without departing from the spirit of the invention.

1. A DC-DC converter system comprising:
a DC-DC converter including a power switching device for converting a voltage of supplied electric power from an input direct current power supply source and producing an output voltage to an electric load system;
a temperature sensor for detecting a temperature of the DC-DC converter; and
a control unit that controls the DC-DC converter so that the output voltage becomes a predetermined target value by switching control of the power switching device at the time of a normal temperature state, and stops operation of the power switching device when a detected temperature exceeds a predetermined operation stop temperature state,
wherein, at the time of an overheat temperature state between the normal temperature state and the operation stop temperature state determined based on the detected temperature, the control unit controls the power switching device so that an output current of the DC-DC converter is limited to be less than a predetermined overheat-time current value that is smaller than a normal limiting current value that is a maximum allowable current value at the normal temperature state and so that the output voltage of the DC-DC converter is limited to be less than a predetermined overheat limiting voltage value that is smaller than the normal limiting voltage value that is a maximum voltage value at the time of the normal temperature state and that is set to be larger than a minimum required voltage value that is required by the load system.

2. The DC-DC converter system according to claim 1,
wherein the control unit reduces at least one of the overheat-time limiting current value and the overheat-time limiting voltage value as the detected temperature rises at the time of the overheat temperature state.

3. The DC-DC converter system according to claim 1,
wherein at the time of the overheat temperature state, the control unit sets the overheat-time limiting voltage value to a value to be higher than an open voltage value of a battery of the electric load system.

4. The DC-DC converter system according to claim 1,
wherein, at the time of the overheat temperature state, the control unit sets a switching frequency of the power switching device to be lower than that of the normal temperature state.

5. (canceled)
